(19) United States
(12) Patent Application Publication
(10) Pub. No.: US 2023/0015835 A1
(43) Pub. Date: Jan. 19, 2023

(54) CURABLE PERFLUOROPOLYETHER ADHESIVE COMPOSITION AND ADHESIVE CONTAINING CURED PRODUCT THEREOF

(71) Applicant: SHIN-ETSU CHEMICAL CO., LTD., Tokyo (JP)

(72) Inventors: Hiroyuki YASUDA, Tomioka-shi (JP); Koichi YAMAGUCHI, Takasaki-shi (JP)

(73) Assignee: SHIN-ETSU CHEMICAL CO., LTD., Tokyo (JP)

(21) Appl. No.: 17/783,113

(22) PCT Filed: Nov. 25, 2020
(86) PCT No.: PCT/JP2020/043874

§ 371 Date: Jun. 7, 2022

(30) Foreign Application Priority Data
Dec. 13, 2019 (JP) 2019-225653

(51) Int. Cl. C09J 171/00; C09J 11/06

(52) U.S. Cl. CPC C09J 171/00; C09J 11/06; C09J 2301/312

(57) ABSTRACT

A curable perfluoropolyether adhesive composition containing: (A) 100 parts by mass of a linear perfluoropolyether compound having at least two alkenyl groups per molecule and having a perfluoropolyether structure containing a repeating unit represented by -CₐF₂ₐO- in a main chain; (B) an organosilicon compound having at least two silicon-bonded hydrogen atoms per molecule; (C) a hydrosilylation-reaction catalyst; (D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

### TECHNICAL FIELD

The present invention relates to: a curable perfluoropolyether adhesive composition (hereinafter, referred to as a perfluoropolyether adhesive composition), a product of which is an adhesive (cured perfluoropolyether rubber or cured perfluoropolyether gel) having excellent heat resistance, oil resistance, chemical resistance, solvent resistance, low-temperature properties, moisture resistance, low gas permeability, and so forth, and in particular favorable adhesive force to resin and metal substrates; and an adhesive including a cured product of the curable perfluoropolyether adhesive composition.

### BACKGROUND ART

Conventionally, it is proposed that a good cured product having well-balanced properties of heat resistance, chemical resistance, solvent resistance, water repellency, oil repellency, weatherability, etc. can be obtained from a composition containing: a linear perfluoropolyether compound having at least two alkenyl groups per molecule and having a perfluoropolyether structure in a main chain; an organosilicon compound having two or more H—SiOSiO structures per molecule; and a hydrosilylation-reaction catalyst (Patent Document 1, Patent Document 2).

Meanwhile, adhesives are used in various situations, mainly labels and adhesive tapes to be attached to products. Recently, uses are expanding accompanying progress in electronic terminal-related technology, and examples include adhesive films for protecting displays and films for protection during product production processes. Furthermore, adhesives are used not only for surface protection, but also for optical members, making use of the transparency of the material. In addition, uses on the inside of products, for example, Optical Clear Adhesive Tapes (OCA tapes) are also being developed.

Main classifications of adhesives include acrylic types, rubber types, silicone types, etc., and each type has advantages and disadvantages. Silicone adhesives have a disadvantage regarding costs compared with acrylic types and rubber types, but have better properties such as heat resistance, cold resistance, weatherability, chemical resistance, and electric insulation property than the other two types of adhesives.

Recently, terminals such as mobile phones have become widespread. Most adhesive films for protecting the displays of such terminals use silicone adhesives. Silicone has favorable wettability to an adherend owing to characteristics thereof. Therefore, air bubbles do not get caught when bonding the adhesive film on and the adhesive film does not shift or peel off of its own accord; besides, it is also possible to rebond the adhesive film since reworkability is good (Patent Document 3). The same is also true regarding protective films for use during product production processes, and heat resistance and so forth are further required. Therefore, a large amount of adhesive film using silicone adhesives is used.

In addition, among mobile phones, terminals called smartphones, having higher performance than conventional mobile phones, are rapidly spreading, and many smartphones until now can be operated by touching a display called a touch screen instead of conventional buttons. Similar terminals include tablets, which are computers that can be carried easily and have a touch screen. Owing to the spreading of these terminals, the area of displays has become large, and accordingly, demands for adhesive films for protecting the screen are rising.

However, although such silicone adhesives have sufficient performance as they are for most uses, there has been strong desire for the emergence of an adhesive composition excellent in chemical resistance and solvent resistance for use on barcode labels and so forth that require further chemical resistance and solvent resistance, used in engines of vehicles and in processes of clinical examination and pathological examination.

In these circumstances, a curable perfluoropolyether adhesive composition is proposed (Patent Document 4). It is shown that this composition gives a cured product excellent not only in heat resistance, weatherability, water repellency, oil repellency, and so forth, but also in chemical resistance and solvent resistance. However, in order to apply and adhere this adhesive to not a tape but a rigid substrate such as resin or metal, a primer has to be applied. Simple primer application process has been demanded.

### CITATION LIST

### Patent Literature

Patent Document 1: JP 2990646 B2

Patent Document 2: JP 2000-248166 A

Patent Document 3: JP H07-197008 A

Patent Document 4: JP 2019-38904 A

### SUMMARY OF INVENTION

### Technical Problem

The present invention has been made in view of the above circumstances, and an object thereof is to provide: a curable perfluoropolyether adhesive composition providing a cured product thereof which has excellent heat resistance, weatherability, water repellency, oil repellency, chemical resistance, solvent resistance, etc., in particular, the cured product being capable of adhering without peeling from resin and metal substrates during heat treatment; and the cured product of the composition.

### Solution to Problem

To achieve the object, the present invention provides a curable perfluoropolyether adhesive composition comprising the following components (A) to (D) :
(A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

A curable perfluoropolyether adhesive composition containing the components (A) to (D) as in the present invention gives a cured product (adhesive) excellent in heat resistance, weatherability, oil resistance, low-temperature properties, moisture resistance, low gas permeability, water repellency, oil repellency, etc. Moreover, the cured product is particularly excellent in chemical resistance and solvent resistance, while also having favorable adhesive force to substrates, for example, resin and metal substrates. Furthermore, the inventive curable perfluoropolyether adhesive composition containing the components (A) to (D) as described above can give rubber-form cured product (cured perfluoropolyether rubber).

In addition, the present invention provides a curable perfluoropolyether adhesive composition comprising the following components (A) to (E):
(A) 40 to 80 parts by mass of a linear perfluoropolyether compound having at least two alkenyl groups per molecule and having a perfluoropolyether structure containing a repeating unit of —CₐF₂ₐO— in a main chain, “a” being an integer of 1 to 6;
(E) 20 to 60 parts by mass of a polyfluoromonoalkenyl compound having one alkenyl group per molecule and having a perfluoropolyether structure in a main chain, a total amount of the components (A) and (E) being 100 parts by mass;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

A curable perfluoropolyether adhesive composition containing the components (A) to (E) as in the present invention gives a cured product (adhesive) excellent in heat resistance, weatherability, oil resistance, low-temperature properties, moisture resistance, low gas permeability, water repellency, oil repellency, etc. Moreover, the cured product is particularly excellent in chemical resistance and solvent resistance, while also having favorable adhesive force to substrates, for example, resin and metal substrates. Furthermore, the inventive curable perfluoropolyether adhesive composition containing the components (A) to (E) as described above can give gel cured product (cured perfluoropolyether gel).

Moreover, the component (E) is preferably a polyfluoromonoalkenyl compound represented by the following general formula (2):
Rf¹— (X') ₚ—CH═CH₂ (2)
wherein X′ represents —CH₂—, —OCH₂—, —CH₂OCH₂—, or —CO—NR₂—Y'—, Y′ represents —CH₂— or a group represented by the following structural formula (Z′),

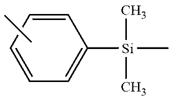

being a dimethylphenylsilylene group in an ortho-, meta-, or para-position, R² represents a hydrogen atom, a methyl group, a phenyl group, or an allyl group, “p” represents 0 or 1, Rf¹ represents a perfluoropolyether structure represented by a general formula F—[CF(CF₃)CF₂O]_{w}—CF(CF₃)—, and “w” represents an integer of 1 to 500.

When the composition contains such a component (E), the curable perfluoropolyether adhesive composition can give a cured product (adhesive) more excellent in chemical resistance and solvent resistance.

Further, the composition is desirably such that a cured product of the curable perfluoropolyether adhesive composition is an adhesive having an adhesion of 0.001 N/25 mm to 10.0 N/25 mm.

When the composition results in such an adhesion, the curable perfluoropolyether adhesive composition enables favorable adhesion to an adherend.

More preferably, the component (A) is a linear perfluoropolyether compound represented by the following general formula (1):

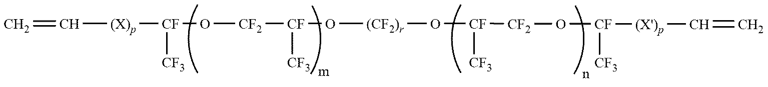

wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y' represents —CH₂— or a group represented by the following structural formula (Z′), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600,

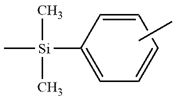

(Z) being a dimethylphenylsilylene group in an ortho-, meta-, or para-position, and

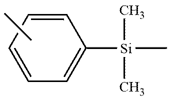

(Z′) being a dimethylphenylsilylene group in an ortho-, meta-, or para-position.

When the composition contains such a component (A), the curable perfluoropolyether adhesive composition gives a cured product (adhesive) more excellent in chemical resistance and solvent resistance and also has high adhesion.

Further, a cured product of the curable perfluoropolyether adhesive composition is preferably a non-conductive adhesive having a volume resistivity of 1x10⁹ Ω·cm or more.

The inventive curable perfluoropolyether adhesive compositions can be used suitably as a material for such a non-conductive adhesive.

In addition, the present invention provides an adhesive comprising a cured product of the above-described curable perfluoropolyether adhesive composition.

In this manner, the inventive curable perfluoropolyether adhesive composition can be used as an adhesive that gives cured perfluoropolyether rubber or cured perfluoropolyether gel excellent in adhesion to various substrates.

### Advantageous Effects of Invention

As described above, the inventive perfluoropolyether adhesive compositions can give adhesive rubber-form or gel-form cured products (adhesives) having excellent in heat resistance, weatherability, oil resistance, low-temperature properties, moisture resistance, low gas permeability, water repellency, oil repellency, etc., particularly excellent in chemical resistance and solvent resistance, the cured products also having favorable adhesion to resin and metal substrates.

### DESCRIPTION OF EMBODIMENTS

As noted above, there have been demands for the development of: a curable perfluoropolyether adhesive composition that gives an adhesive cured product (adhesive) excellent in heat resistance, weatherability, water repellency, oil repellency, etc., particularly excellent in chemical resistance and solvent resistance, the cured product further having favorable adhesive force to resin and metal substrates; and an adhesive containing the cured product.

To achieve the object, the present inventors have earnestly studied and consequently found that by using a particular perfluoropolyether adhesive composition according to the present invention, it is possible to obtain an adhesive composition resulting in a rubber-form or gel-form cured product (cured perfluoropolyether rubber or cured perfluoropolyether gel) more excellent in chemical resistance and solvent resistance than conventional silicone adhesives. This finding has led to the present invention.

Specifically, a first embodiment of the present invention is a curable perfluoropolyether adhesive composition that gives a rubber-form cured product (cured perfluoropolyether rubber), the curable perfluoropolyether adhesive composition containing the following components (A) to (D):
(A) 100 parts by mass of a linear perfluoropolyether compound having at least two alkenyl groups per molecule and having a perfluoropolyether structure containing a repeating unit represented by -CₐF₂ₐO- in a main chain, “a” being an integer of 1 to 6;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

Hereinafter, the first embodiment of the present invention will be described in detail, but the present invention is not limited thereto.

### Component (A)

The component (A) contained in the inventive curable perfluoropolyether adhesive composition functions as a main ingredient (base polymer) of the inventive curable perfluoropolyether adhesive composition, and is a linear perfluoropolyether compound having at least two alkenyl groups per molecule and having a perfluoropolyether structure (perfluorooxyalkylene structure), preferably a divalent perfluorooxyalkylene structure, in a main chain.

Here, examples of the perfluorooxyalkylene structure include those containing a repeating structure of many oxyalkylene units shown by —CₐF₂ₐO— (in the formula, “a” in each unit independently represents an integer of 1 to 6), for example, those shown by the following general formula (5), etc.

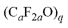

In the formula, “q” is an integer of 50 to 600, preferably an integer of 50 to 400, more preferably an integer of 50 to 200.

Examples of the individual repeating structures —CₐF₂ₐO— (i.e., oxyalkylene units) constituting the perfluorooxyalkylene structure shown by the formula (5) include the following structures and the like. Note that the perfluoroalkyl ether structure may be constituted by one kind of these repeating structures, or may be a combination of two or more kinds thereof.
—CF₂O—
—CF₂CF₂O—
—CF₂CF₂CF₂O—
—CF(CF₃)CF₂O—
—CF₂CF₂CF₂CF₂O—
—CF₂CF₂CF₂CF₂CF₂CF₂O—
—C(CF₃)₂O—

Among these, the following structures are particularly suitable.
—CF₂O—
—CF₂CF₂O—
—CF₂CF₂CF₂O—
—CF (CF₃) CF₂O—

Note that in the present invention, “linear” indicates that the individual repeating units -CₐF₂ₐO-(oxyalkylene units) constituting the perfluoropolyether structure (perfluorooxyalkylene structure) of the main chain are bonded to one another linearly, and each of the repeating units (oxyalkylene units) themselves may be a linear oxyalkylene unit or a branched oxyalkylene unit (e.g., —CF(CF₃)CF₂O—, —C(CF₃)₂O—, etc.).

As the alkenyl groups in the linear perfluoropolyether compound of the component (A), those having 2 to 8 carbon atoms, in particular, 2 to 6 carbon atoms, and having a CH₂═CH— structure on a terminal are preferable. For example, groups having a CH₂═CH—structure on a terminal, such as a vinyl group, an allyl group, a propenyl group, an isopropenyl group, a butenyl group, and a hexenyl group are preferable, and a vinyl group, an allyl group, etc. are particularly preferable. These alkenyl groups may be bonded directly to both terminals of the perfluoropolyether structure, in particular, the divalent perfluorooxyalkylene structure, constituting the main chain of the linear perfluoropolyether compound. Alternatively, the alkenyl groups may be bonded through a divalent linking group, for example, —CH₂—, —CH₂O—, —CH₂OCH₂—, or —Y—NR—CO—, provided that Y is a group represented by —CH₂— or the following structural formula (Z),

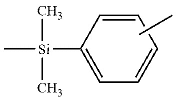

(Z) being a dimethylphenylsilylene group in an ortho-, meta-, or para-position. R represents a hydrogen atom, a methyl group, a phenyl group, or an allyl group. Furthermore, the component (A) has at least two alkenyl groups per molecule.

Examples of the component (A) include polyfluorodialkenyl compounds represented by the following general formula (6) or (7).

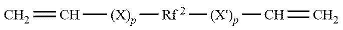

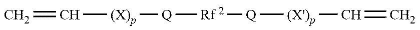

In the formulae, X independently represents —CH₂—, —CH₂O—, —CH₂OCH₂—, or —Y—NR¹—CO—, provided that Y is a group represented by —CH₂— or the following structural formula (Z) and R¹ represents a hydrogen atom, a methyl group, a phenyl group, or an allyl group. X′ represents —CH₂—, —OCH₂—, —CH₂OCH₂—, or —CO—NR²—Y'—, provided that Y′ is a group represented by —CH₂— or the following structural formula (Z′) and R² represents a hydrogen atom, a methyl group, a phenyl group, or an allyl group.

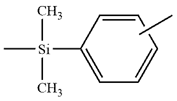

(Z) is a dimethylphenylsilylene group in an ortho-, meta-, or para-position.

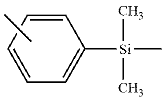

(Z′) is a dimethylsilylphenylene group in an ortho-, meta-, or para-position.

Rf² represents a divalent perfluoropolyether structure (perfluorooxyalkylene structure), preferably one represented by the formula (5), that is, (CₐF₂ₐO)_{q}. Q represents a divalent hydrocarbon group having 1 to 15 carbon atoms and optionally containing an ether bond. Specific examples of Q include alkylene groups and alkylene groups optionally containing an ether bond. “p” independently represents 0 or 1.

As such a component (A) linear perfluoropolyether compound, a compound shown by the following general formula (1) is particularly suitable.

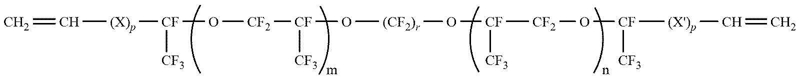

In the formula, X, X' and “p” are as defined above. “r” represents an integer of 2 to 6. “m” and “n” each represent an integer of 0 to 600, and furthermore, the sum of “m” and “n” is 50 to 600.

The linear perfluoropolyether compound of the general formula (1) desirably has a weight-average molecular weight of 3,000 to 100,000, particularly desirably 4,000 to 50,000 in molecular weight distribution measurement by gel permeation chromatography (GPC) analysis using a fluorine-based eluent as a developing solvent in terms of polyethylene. When the weight-average molecular weight is 4,000 or more, swelling of the compound in gasoline and other solvents is small. In particular, swelling in gasoline becomes 6% or lower, and the compound can meet the requirements of a material that requires gasoline resistance. Meanwhile, a weight-average molecular weight of 100,000 or less is practical since such a compound is not too viscous and is excellent in workability. Note that the value of the degree of polymerization (m+n) of the linear perfluoropolyether compound of the general formula (1) can be similarly determined as a number-average polymerization degree, weight-average polymerization degree, or the like in molecular weight distribution measurement by gel permeation chromatography (GPC) analysis using a fluorine-based eluent as a developing solvent in terms of polyethylene. Note that the number-average polymerization degree and number-average molecular weight can also be calculated from the ratio of the terminal structures to the repeating unit structures obtained from a ¹⁹F-NMR spectrum.

Specific examples of the linear perfluoropolyether compound represented by the general formula (1) include those represented by the following formulae.

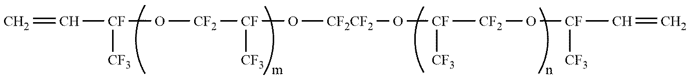

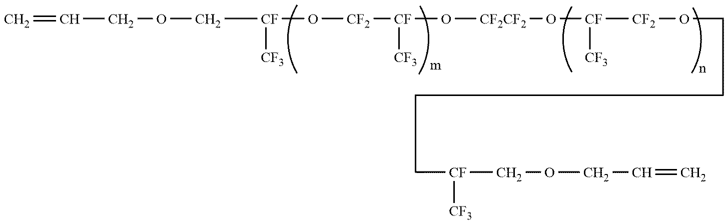

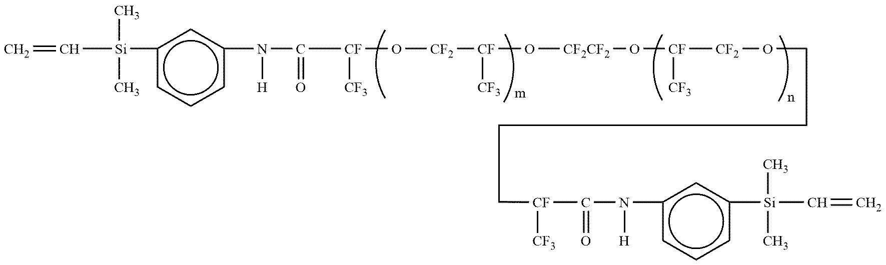

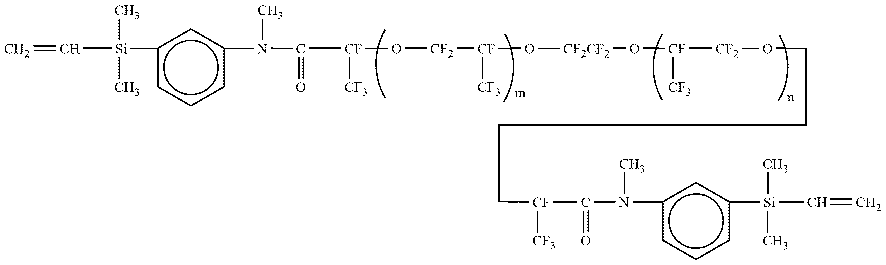

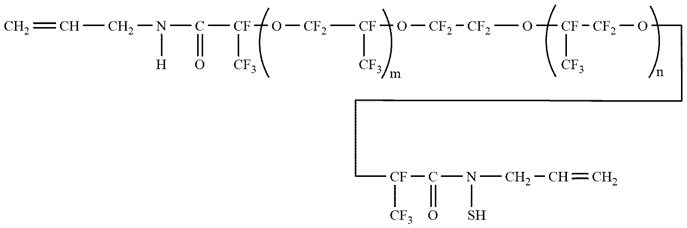

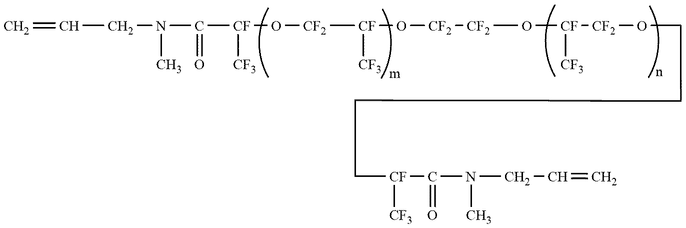

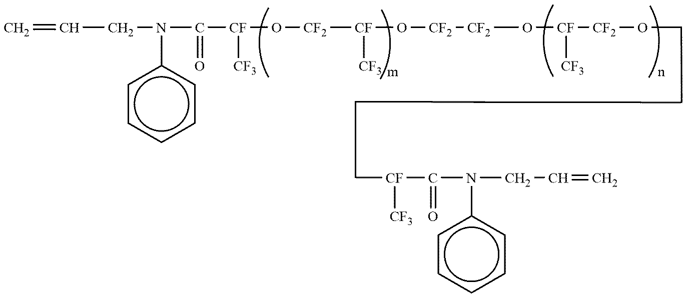

In the formulae, “m” and “n” each represent an integer of 0 to 600, preferably an integer of 0 to 200, and satisfy m+n=50 to 600, preferably m+n=50 to 200.

Furthermore, in the present invention, in order to adjust the linear perfluoropolyether compound of the formula (1) to have a desired weight-average molecular weight according to the purpose, it is also possible to subject the above-described linear perfluoropolyether compound to a hydrosilylation reaction beforehand with an organosilicon compound containing two SiH groups in a molecule according to an ordinary method and under ordinary conditions; the resulting chain-extended product can be used as the component (A). Incidentally, one kind of the component (A) linear perfluoropolyether compound may be used, or two or more kinds thereof may be used in combination.

### Component (B)

The component (B) serves as a crosslinking agent and/or chain extender for the component (A). The component (B) is an organosilicon compound such as an organohydrogenpolysiloxane having at least two, preferably three or more, silicon-bonded hydrogen atoms (hydrosilyl groups represented by SiH) per molecule. Examples of the component (B) include known organosilicon compounds disclosed in Patent Document 1, Patent Document 2, and Patent Document 4, but are not particularly limited.

Note that the organosilicon compound of the component (B) is clearly distinguished from an organosilicon compound of the component (D) to be described later in that the component (B) does not contain such functional groups as an epoxy group and a trialkoxysilyl group in the molecule.

Note that as the component (B) organosilicon compound, it is possible to use suitably a fluorine-containing organohydrogenpolysiloxane having one group or more groups of monovalent perfluoroalkyl groups, monovalent perfluorooxyalkyl groups, divalent perfluoroalkylene groups, and/or divalent perfluorooxyalkylene groups per molecule in view of compatibility with the component (A), or compatibility with the component (A) and a component (E) described below in a second embodiment of the present invention described below, dispersibility, uniformity of the cured rubber product or cured gel product (adhesive), and so forth.

Examples of the monovalent or divalent fluorine-containing organic group include perfluoroalkyl groups, perfluorooxyalkyl groups, perfluoroalkylene groups, perfluorooxyalkylene groups, etc. represented by the following formulae:
C_{g}F_{2g+1}-
-C_{g}F_{2g}-
(where “g” is an integer of 1 to 20, preferably an integer of 2 to 10);

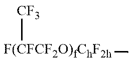

(where “f” is an integer of 1 to 200, preferably an integer of 1 to 100, and “h” is an integer of 1 to 3);

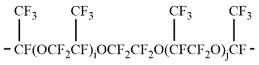

(where “i” and “j” are each an integer of 1 or more, preferably an integer of 1 to 100, and the average of i+j is 2 to 200, preferably 2 to 100); and
— (CF₂O) _{d}— (CF₂CF₂O) ₑ—CF₂—
(where “d” and “e” are each an integer of 1 to 50, preferably an integer of 1 to 40.)

Furthermore, these perfluoroalkyl groups, perfluorooxyalkyl groups, perfluoroalkylene groups, or perfluorooxyalkylene groups are preferably joined to a silicon atom via a divalent linking group. The divalent linking group may be an alkylene group, an arylene group, a combination thereof, or any of these groups having an intervening ether-bond oxygen atom, amide bond, carbonyl bond, ester bond, diorganosilylene group, or the like. Examples thereof include the following divalent linking groups having 2 to 12 carbon atoms, etc., but are not limited thereto.
—CH₂CH₂—,
—CH₂CH₂CH₂—,
—CH₂CH₂CH₂OCH₂—,
—CH₂CH₂CH₂—NH—CO—,
—CH2CH2CH2—N (Ph) —CO—,
—CH₂CH₂CH₂—N (CH₃) —CO—,
—CH₂CH₂CH₂—N (CH₂CH₃) —CO—,
—CH₂CH₂—Si(CH₃)₂—Ph'—N(CH₃)—CO—,
—CH₂CH₂CH₂—Si (CH₃) ₂—Ph' —N (CH₃) —CO—,
—CH₂CH₂CH₂—O—CO
In the formulae, Ph represents a phenyl group, and Ph' represents a phenylene group.

Furthermore, examples of silicon-bonded monovalent substituents other than the monovalent or divalent fluorine-containing organic group and silicon-bonded hydrogen atoms in the fluorine-containing organohydrogenpolysiloxane of the component (B) include alkyl groups, such as a methyl group, an ethyl group, a propyl group, a butyl group, a hexyl group, a cyclohexyl group, an octyl group, and a decyl group; alkenyl groups, such as a vinyl group and an allyl group; aryl groups, such as a phenyl group, a tolyl group, and a naphthyl group; aralkyl groups, such as a benzyl group and a phenylethyl group; and such groups having some or all of the hydrogen atoms thereof substituted with a chlorine atom, a cyano group, etc., for example, unsubstituted or substituted monovalent hydrocarbon groups having 1 to 20, preferably 1 to 12 carbon atoms, such as a chloromethyl group, a chloropropyl group, and a cyanoethyl group.

The component (B) fluorine-containing organohydrogenpolysiloxane may be cyclic, linear, branched, three-dimensional network, or a combination thereof. The number of silicon atoms in the fluorine-containing organohydrogenpolysiloxane is not particularly restricted, but is usually 2 to 60, preferably about 3 to 30. The component (B) fluorine-containing organohydrogenpolysiloxane is particularly preferably a fluorine-containing organohydrogenpolysiloxane having a cyclic structure containing a monovalent perfluoroalkyl group or a monovalent perfluorooxyalkyl group; or a fluorine-containing organohydrogenpolysiloxane having branched or cyclic organohydrogenpolysiloxane structures on both terminals of a divalent perfluoroalkylene group or a divalent perfluorooxyalkylene group.

Examples of such a component (B) having a monovalent or divalent fluorine-containing organic group and silicon-bonded hydrogen atoms include the following compounds. One kind of these compounds may be used, or two or more kinds thereof may be used in combination. Note that in the following formulae, Me represents a methyl group, and Ph represents a phenyl group.

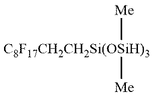

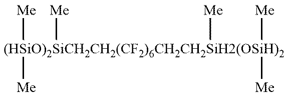

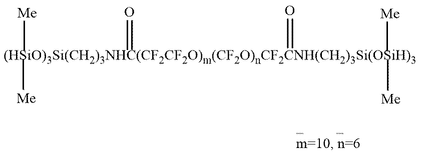

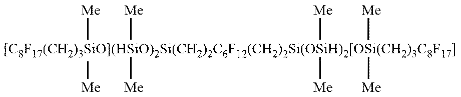

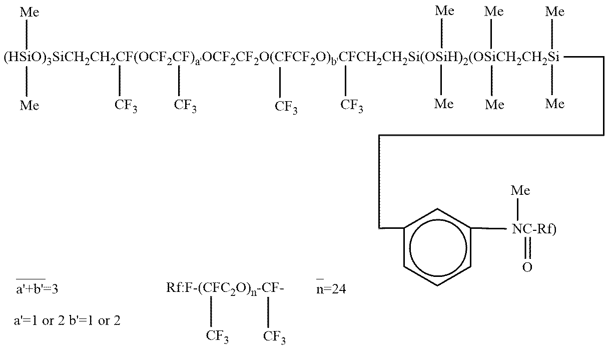

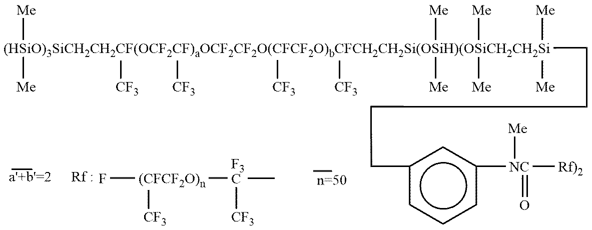

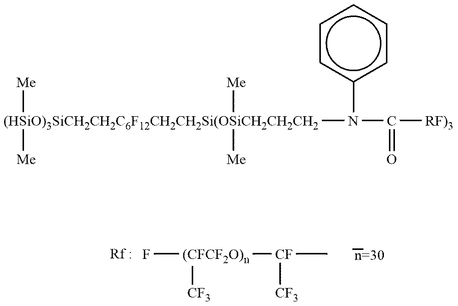

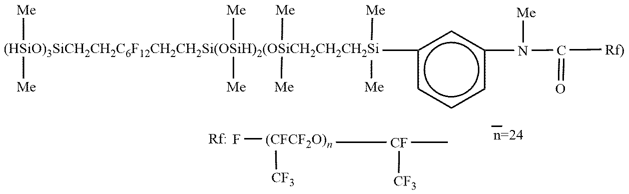

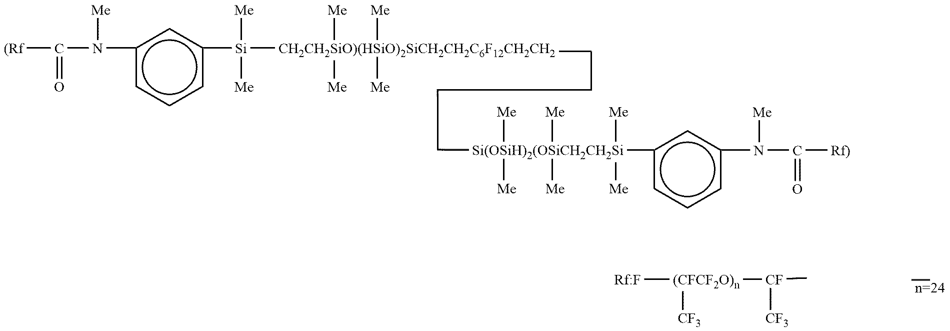

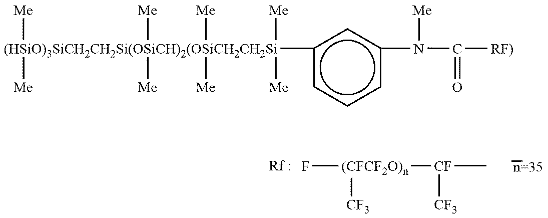

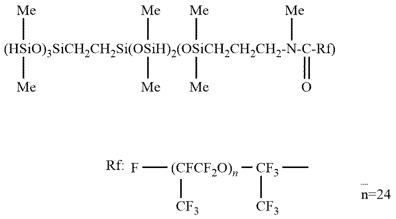

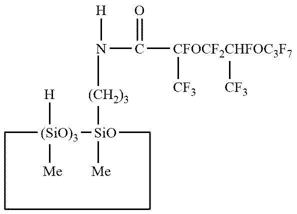

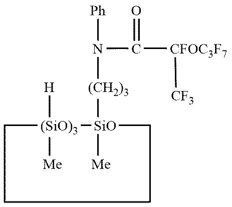

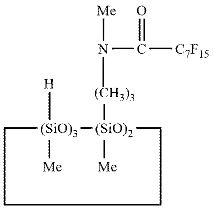

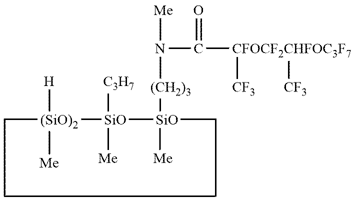

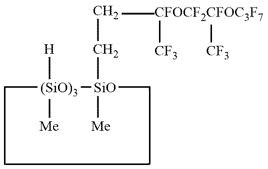

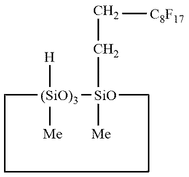

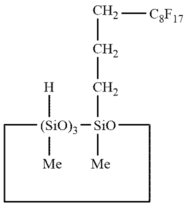

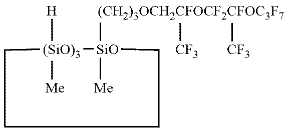

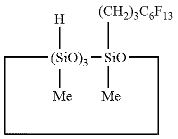

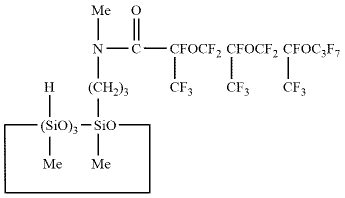

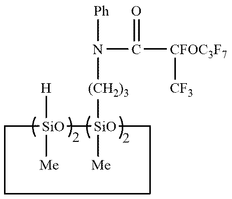

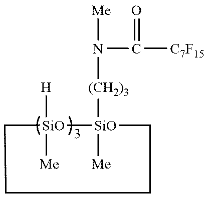

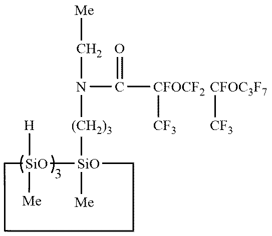

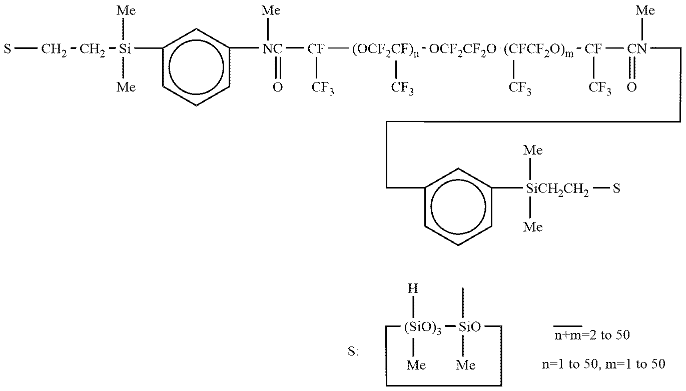

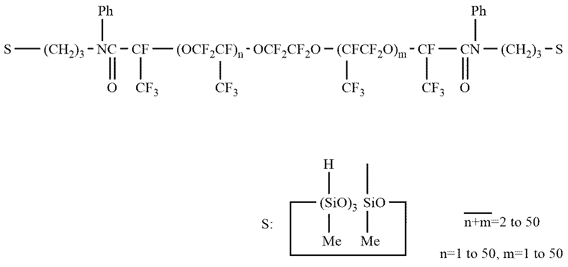

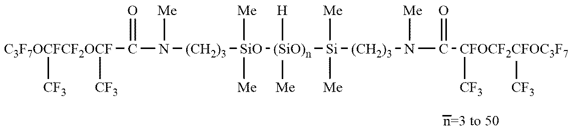

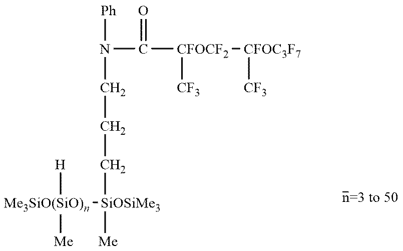

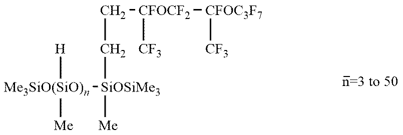

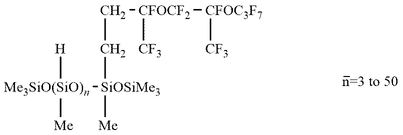

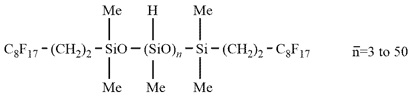

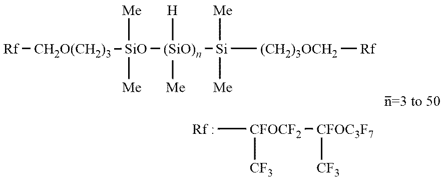

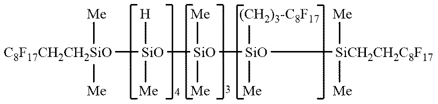

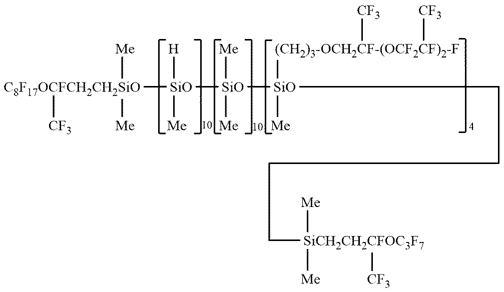

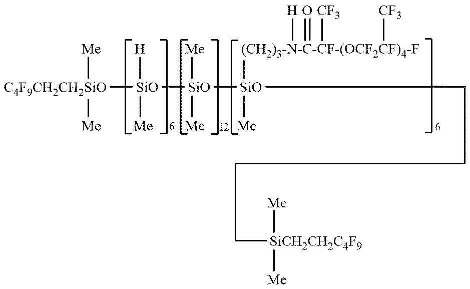

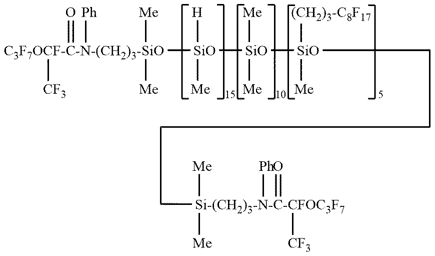

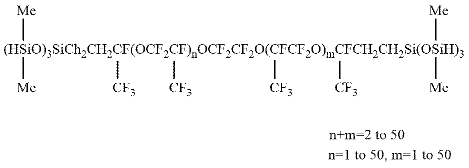

The blended amount of the component (B) is an effective amount for curing the component (A) and the component (E) described below, that is, an effective curing amount. In particular, the blended amount is an amount at which there is preferably 0.2 to 4 mol, more preferably 0.5 to 3 mol of the hydrosilyl groups (Si-H) in the component (B) per 1 mol of the alkenyl groups contained in the component (A) in the present composition, or per 1 mol of a total of the alkenyl groups contained in the component (A) and the component (E) in the second embodiment of the present invention described below. When the amount of the hydrosilyl groups (Si—H) is 0.2 mol or more, the degree of crosslinking is sufficient, and there is no risk that a cured product cannot be obtained. Meanwhile, when the amount of the hydrosilyl groups (Si—H) is 4 mol or less, there is no risk of foaming during curing.

One kind of the component (B) can be used, or a combination of two or more kinds thereof can be used.

### Component (C)

The component (C) hydrosilylation-reaction catalyst (addition-reaction catalyst) of the present invention is a catalyst that promotes an addition reaction between the hydrosilyl groups in the component (B) and the alkenyl groups in the component (A), or the alkenyl groups in the component (A) and the component (E) described below in the second embodiment of the present invention described below. This hydrosilylation-reaction catalyst is generally a noble metal (platinum group metal) compound, which is expensive, and therefore, platinum or a platinum compound, which are relatively readily available, are often used.

Examples of the platinum compound include chloroplatinic acid, complexes of chloroplatinic acid with olefins such as ethylene, complexes of chloroplatinic acid with alcohols or vinylsiloxanes, metallic platinum supported on silica, alumina, carbon, or the like, etc. Known platinum group metal catalysts other than the platinum compounds include rhodium-, ruthenium-, iridium-, and palladium-based compounds. Examples thereof include RhCl (PPh₃)₃, RhCl (CO) (PPh₃)₂, Ru₃ (CO)₁₂, IrCl (CO) (PPh₃)₂, Pd(PPh₃)₄, etc.

The blended amount of the hydrosilylation-reaction catalyst can be a catalytic amount. Usually, the hydrosilylation-reaction catalyst is preferably contained in an amount of 0.1 to 500 ppm (in terms of the mass of the platinum group metal), more preferably 0.1 to 100 ppm based on the total mass of the components (A), (B), and (E). One kind of the component (C) hydrosilylation-reaction catalyst can be used, or a combination of two or more kinds thereof can be used.

### Component (D)

The component (D) is an organosilicon compound such as organosilane and organopolysiloxane having an adhesive functional group, and serves as an auxiliary agent (adhesive aid or adhesion improver) for improving the adhesiveness to a substrate. Such an organosilicon compound is an organosilicon compound (organo(hydrogen)silane, organo(hydrogen)polysiloxane) having, per molecule, at least two or more adhesive functional groups which are any two or more selected from a silicon-bonded hydrogen atom (SiH group), an epoxy group bonded to a silicon atom via a carbon atom or via a carbon atom and an oxygen atom, and a trialkoxysilyl group bonded to a silicon atom via a carbon atom or via a carbon atom and an oxygen atom. Preferably, the organopolysiloxane furthermore has one or more monovalent perfluoroalkyl groups or monovalent perfluorooxyalkyl groups each bonded to a silicon atom via a divalent linking group which contains a carbon atom or a carbon atom and an oxygen atom, and which is bonded to the silicon atom (i.e., preferably a fluorine-containing organo(hydrogen)polysiloxane containing adhesive functional groups).

From the viewpoint of substrate-adhesiveness improvement, the component (D) organosilicon compound is more preferably: a (fluorine-containing) organohydrogenpolysiloxane containing a silicon-bonded hydrogen atom (SiH group) as essential moiety and further containing an epoxy group bonded to a silicon atom via a carbon atom or via a carbon atom and an oxygen atom among the two or more adhesive functional groups in a molecule; a (fluorine-containing) organohydrogenpolysiloxane containing a silicon-bonded hydrogen atom (SiH group) as essential moiety and further containing a trialkoxysilyl group bonded to a silicon atom via a carbon atom or via a carbon atom and an oxygen atom in a molecule; or a (fluorine-containing) organohydrogenpolysiloxane containing a silicon-bonded hydrogen atom (SiH group) as essential moiety and further containing an epoxy group bonded to a silicon atom via a carbon atom or via a carbon atom and an oxygen atom and a trialkoxysilyl group bonded to a silicon atom via a carbon atom or via a carbon atom and an oxygen atom in a molecule. Note that the component (D) differs from the component (B) in that the component (D) contains an epoxy group and/or a trialkoxysilyl group in a molecule.

Such an organopolysiloxane has a siloxane skeleton which may be cyclic, linear, branched, a mixture thereof, etc.

Specific examples of the component (D) include adhesive-functional-group-containing hydrolyzable organosilane compounds (what is called epoxy group-containing silane coupling agents) having an epoxy group and a trialkoxysilyl group in a molecule, such as γ-glycidoxypropyltrimethoxysilane, γ-glycidoxypropyltriethoxysilane, β-(3,4-epoxycyclohexyl)ethyltrimethoxysilane, β-(3,4-epoxycyclohexyl)ethyltriethoxysilane, β-(2,3-epoxycyclohexyl)ethyltrimethoxysilane, β-(2,3-epoxycyclohexyl)ethyltriethoxysilane, and other adhesive-functional-group-containing hydrolyzable organosilane compounds having an epoxy group and a trialkoxysilyl group in a molecule. Besides, it is possible to use organopolysiloxanes shown by the following formulae; etc.

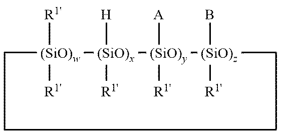

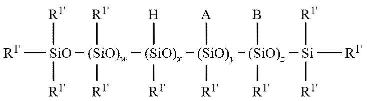

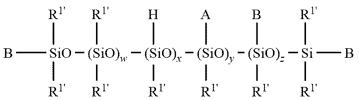

In the formulae, R¹' independently represents an unsubstituted or halogen-substituted monovalent hydrocarbon group. “A” and “B” are described below. “w” represents an integer of 0≤w≤100, “x” represents an integer of 1≤x≤100, “y” represents an integer of 1≤y≤100, and “z” represents an integer of 0≤z≤100.

The halogen-substituted or unsubstituted monovalent hydrocarbon group as R¹' has preferably 1 to 10 carbon atoms, particularly preferably 1 to 8 carbon atoms. Specific examples thereof include alkyl groups, such as a methyl group, an ethyl group, a propyl group, a butyl group, a hexyl group, a cyclohexyl group, and an octyl group; aryl groups, such as a phenyl group and a tolyl group; aralkyl groups, such as a benzyl group and a phenylethyl group; etc.; substituted monovalent hydrocarbon groups obtained from these groups by substituting some or all of hydrogen atoms thereof with a halogen atom, such as fluorine; etc. Among these, a methyl group is particularly preferable.

Preferably, “w” is an integer of 0≤w≤20, “x” is an integer of 1≤x≤20, “y” is an integer of 1≤y≤20, and “z” is an integer of 1≤z≤20, with 3≤w+x+y+z≤50.

“A” represents an epoxy group bonded to a silicon atom via a carbon atom or via a carbon atom and an oxygen atom, and/or a trialkoxysilyl group bonded to a silicon atom via a carbon atom or via a carbon atom and an oxygen atom. Specific examples of “A” include the following groups:

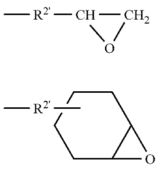

[where R²' represents a divalent hydrocarbon group (such as alkylene group, cycloalkylene group) having 1 to 10 carbon atoms, particularly 1 to 5 carbon atoms optionally having an intervening oxygen atom];
—R³—Si(OR⁴)₃
[where R³ represents a divalent hydrocarbon group (such as alkylene group) having 1 to 10 carbon atoms, particularly 1 to 4 carbon atoms, and R⁴ represents a monovalent hydrocarbon group (such as alkyl group) having 1 to 8 carbon atoms, particularly 1 to 4 carbon atoms]; and

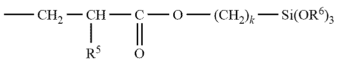

[where R⁵ represents a monovalent hydrocarbon group (such as alkyl group) having 1 to 8 carbon atoms, particularly 1 to 4 carbon atoms; R⁶ represents a hydrogen atom or a methyl group; and “k” represents an integer of 2 to 10.]

“B” represents a monovalent perfluoroalkyl group or perfluorooxyalkyl group bonded to a silicon atom via a carbon atom or via a carbon atom and an oxygen atom. Examples of the monovalent perfluoroalkyl group or perfluorooxyalkyl group include ones shown by the following general formulae; etc.

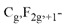

(where g′ represents an integer of 1 to 20, preferably an integer of 2 to 10.)

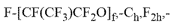

(where f′ represents an integer of 2 to 200, preferably an integer of 2 to 100, and h′ represents an integer of 1 to 3)

The divalent linking group containing a carbon atom or a carbon atom and an oxygen atom may be an alkylene group, an arylene group, a combination thereof, or any of these groups having an intervening ether-bond oxygen atom, amide bond, carbonyl bond, or the like. Examples thereof include divalent linking groups having 2 to 12 carbon atoms, such as
—CH₂CH₂—,
—CH₂CH₂CH₂—,
—CH₂CH₂CH₂OCH₂—,
—CH₂CH₂CH₂—NH—CO—,
—CH₂CH₂CH₂—N(CH₃) —CO—, and
—CH₂CH₂CH₂—N (Ph) —CO—,
where Ph represents a phenyl group.

These organopolysiloxanes can be obtained by subjecting an organohydrogenpolysiloxane having three or more silicon-bonded hydrogen atoms (Si—H groups) per molecule, a compound containing an aliphatic unsaturated group, such as a vinyl group and an allyl group, and an epoxy group and/or a trialkoxysilyl group, and if necessary a compound containing an aliphatic unsaturated group and a perfluoroalkyl group or a perfluorooxyalkyl group, to partial addition reaction according to a conventional method. Note that the number of the aliphatic unsaturated groups needs to be smaller than the number of Si—H groups.

In such organopolysiloxane production, the target substance may be isolated after the reaction is completed. It is also possible to use the resulting mixture from which merely the unreacted materials and addition-reaction catalyst have been removed.

Specific examples of the component (D) organopolysiloxane include ones shown by the following structural formulae. Note that, in the following formulae, Me represents a methyl group, and Ph represents a phenyl group.

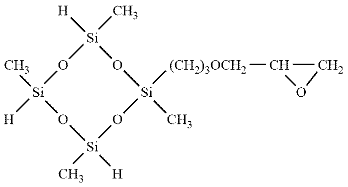

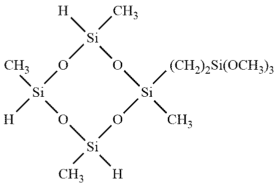

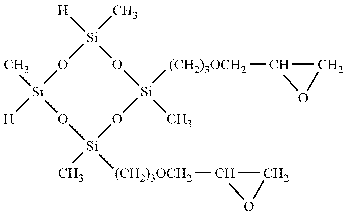

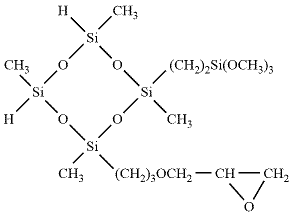

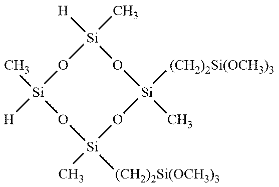

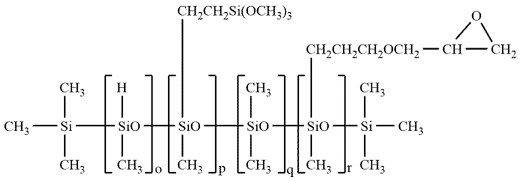

“o”, “q”, and “r” each represent a positive integer, and “p” represents an integer of 0 or more.

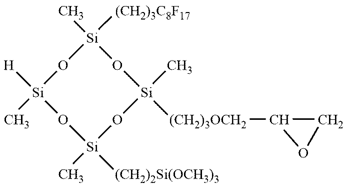

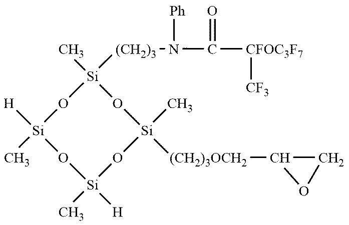

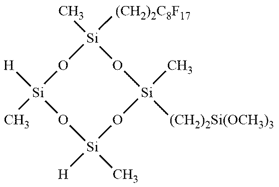

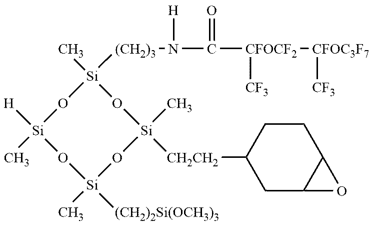

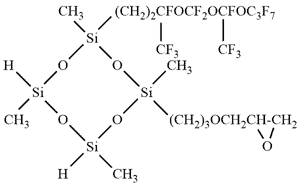

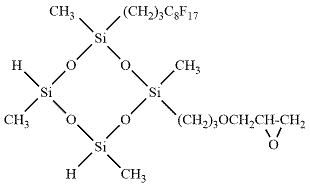

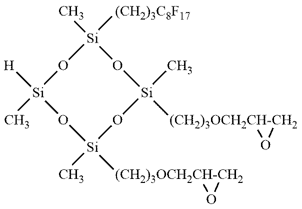

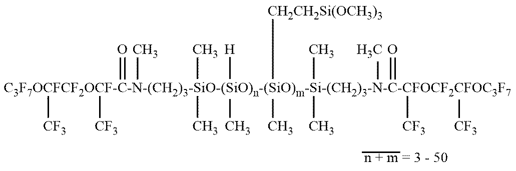

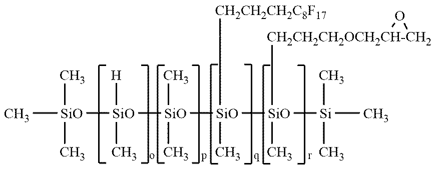

“o”, “q”, and “r” each represent a positive integer, and “p” represents an integer of 0 or more.

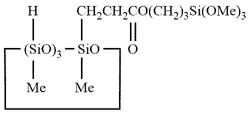

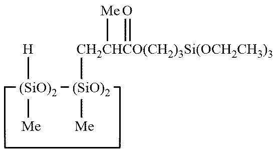

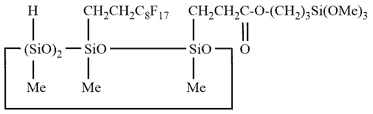

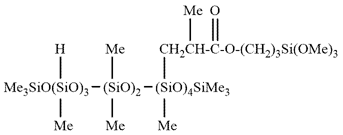

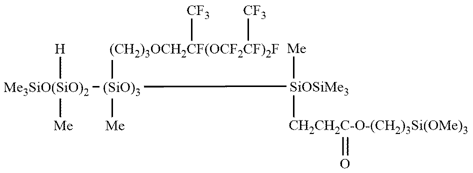

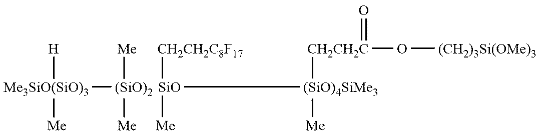

One kind of the component (D) may be used, or two or more kinds thereof may be used in combination.

The component (D) is used in an amount ranging from 0.05 to 5.0 parts by mass, preferably 0.1 to 3.0 parts by mass, more preferably 0.2 to 1.0 parts by mass, based on 100 parts by mass of the component (A), or based on 100 parts by mass of a total of the component (A) and the component (E) described below in the second embodiment of the present invention described later. If the amount is less than 0.05 parts by mass, the effect of blending it cannot be obtained. If the amount exceeds 5.0 parts by mass, this lowers the fluidity of the composition and may impair the curability.

### Other Components

Besides the components (A) to (D), the inventive composition may optionally contain various additives. Examples of regulators for hydrosilylation-reaction catalyst include acetylenic alcohols, such as 1-ethynyl-1-hydroxycyclohexane, 3-methyl-1-butyn-3-ol, 3,5-dimethyl-1-hexyn-3-ol, 3-methyl-1-penten-3-ol, and phenylbutynol; 3-methyl-3-penten-1-yne, 3,5-dimethyl-3-hexen-1-yne, and the like; polymethylvinylsiloxane cyclic compounds; organophosphorus compounds; etc. Adding these can appropriately maintain the curing reactivity and storage stability.

In addition, the second embodiment of the present invention provides a curable perfluoropolyether adhesive composition that gives a gel-form cured product (cured perfluoropolyether gel), the curable perfluoropolyether adhesive composition containing the following components (A) to (E):
(A) 40 to 80 parts by mass of a linear perfluoropolyether compound having at least two alkenyl groups per molecule and having a perfluoropolyether structure containing a repeating unit of -CₐF₂ₐO- in a main chain, “a” being an integer of 1 to 6;
(E) 20 to 60 parts by mass of a polyfluoromonoalkenyl compound having one alkenyl group per molecule and having a perfluoropolyether structure in a main chain, a total amount of the components (A) and (E) being 100 parts by mass;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

As the components (A) to (D) in this embodiment, the same components as those described above can be used.

### Component (E)

The component (E) is a component that is used in this specific second embodiment (i.e., the composition that gives cured gel) as opposed to the above-described first embodiment of the present invention (i.e., the composition that gives a cured rubber) in the inventive curable perfluoropolyether adhesive composition. The component (E) is a polyfluoromonoalkenyl compound having one alkenyl group per molecule and having a perfluoropolyether structure in a main chain. Particularly, a polyfluoromonoalkenyl compound of the following formula (2) is preferable. Rf¹—(X')ₚ—CH═CH₂ (2) In the formula, X' and “p” are as defined above, and Rf¹ is shown by the following general formula. F—[CF(CF₃)CF₂O]_{w}—CF(CF₃)—In the formula, “w” represents an integer of 1 to 500, preferably an integer of 2 to 200.

Specific examples of the polyfluoromonoalkenyl compound represented by the general formula (2) include the following.

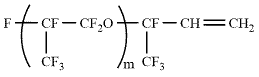

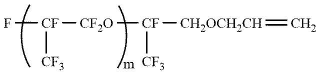

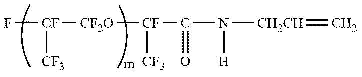

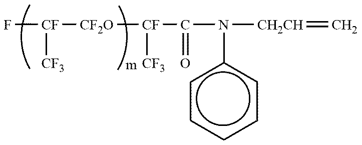

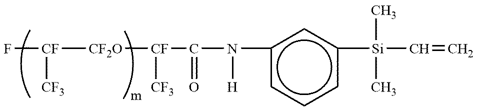

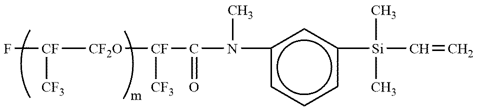

In the formulae, “m” is an integer of 1 to 200, particularly an integer of 2 to 100.

When the polyfluoromonoalkenyl compound of the formula (2) is blended, the amount to be blended is selected so that in the curable perfluoropolyether adhesive composition, the ratio of the component (A) linear perfluoropolyether dialkenyl compound to the component (E) in the inventive composition is: 40 to 80 parts by mass of the component (A) to 20 to 60 parts by mass of the component (E), where the total amount of the component (A) and the component (E) is 100 parts by mass.

### Other Components

In the present composition, various additives can be optionally contained besides the components (A) to (E) as in the first embodiment. Examples of regulators for hydrosilylation-reaction catalyst include those described above.

### Cured Product

The inventive perfluoropolyether adhesive composition forms an adhesive including cured perfluoropolyether rubber or cured perfluoropolyether gel having a surface adhesion of, for example, 0.001 to 10.0 N/25 mm, preferably 0.002 to 8.0 N/25 mm, more preferably 0.003 to 6.0 N/25 mm, by curing the composition. The inventive perfluoropolyether adhesive composition can form a cured product (adhesive) being excellent in heat resistance, water repellency, oil repellency, weatherability, chemical resistance, solvent resistance, and so forth, and having favorable adhesive force to resin and metal substrates, thus enabling uses for various purposes.

For example, in the first embodiment of the present invention, the perfluoropolyether adhesive composition can be cured to form the cured product by using: based on 100 parts by mass of the component (A), the component (B) in such an amount that 0.2 to 3.0 mol of the hydrosilyl groups in the component (B) is contained per 1 mol of the total of the alkenyl groups contained in the component (A); 0.05 to 5.0 parts by mass of the component (D) based on 100 parts by mass of the component (A); and 0.1 to 100 ppm of the component (C) based on a total amount of the components (A), (B) and (D) in terms of platinum.

In addition, for example, in the second embodiment of the present invention, the perfluoropolyether adhesive composition can be cured to form the cured product by using: 20 to 60 parts by mass of the component (E) based on 40 to 80 parts by mass of the component (A) provided that the total of the components (A) and (E) is 100 parts by mass; the component (B) in such an amount that 0.2 to 3.0 mol of the hydrosilyl groups in the component (B) is contained per 1 mol of the total of the alkenyl groups contained in the components (A) and (E); 0.05 to 5.0 parts by mass of the component (D) based on 100 parts by mass of the components (A) and (E); and 0.1 to 100 ppm of the component (C) based on a total amount of the components (A), (B), (D), and (E) in terms of platinum.

The formation of the perfluoropolyether adhesive composition is followed by coating an appropriate substrate with one of the inventive compositions and then curing the composition, or by a conventionally known method by bonding or the like. Curing can be performed easily, usually by a heat treatment at a temperature of 60 to 150° C. and of about 1 to 30 minutes.

The inventive adhesive made from the inventive perfluoropolyether adhesive composition can be used, for example, for automobiles, chemical plants, semiconductor manufacturing lines, analytical or scientific instruments, medical equipment, aircraft, and optical components.

Moreover, the substrate used in the present invention is not particularly limited, and examples thereof include metals, such as iron, aluminum, and stainless steel; glasses; ceramics; synthetic resins, such as PPS, PBT, PET, and nylon; etc.

Further, to enhance the surface modification effect, before the plasma irradiation is performed, the substrate surface may be subjected to degreasing with an organic solvent, prebaking, etc.

Furthermore, the cured product (cured perfluoropolyether rubber or cured perfluoropolyether gel) of the inventive curable perfluoropolyether adhesive composition is preferably a non-conductive adhesive having a volume resistivity of 1x10⁹ Ω·cm or more. Such a curable perfluoropolyether adhesive composition of the present invention is suitable as a material for a non-conductive adhesive. The upper limit of the volume resistivity of the cured product of the inventive curable perfluoropolyether adhesive composition is not particularly limited, but can be, for example, 1x10¹³ Ω·cm.

Such a perfluoropolyether adhesive composition of the present invention provides an excellent cured product (adhesive) having excellent heat resistance, weatherability, oil resistance, chemical resistance, solvent resistance, low-temperature properties, moisture resistance, low gas permeability, water repellency, oil repellency, etc., and particularly having favorable adhesive force to resin and metal substrates.

In addition, a third embodiment of the present invention is the adhesive including the cured product (cured perfluoropolyether rubber or cured perfluoropolyether gel) of the inventive curable perfluoropolyether adhesive composition described above.

As described above, the inventive perfluoropolyether adhesive composition can give an excellent cured product (adhesive) being excellent in heat resistance, weatherability, oil resistance, chemical resistance, solvent resistance, low-temperature properties, moisture resistance, low gas permeability, water repellency, oil repellency, and so forth, and particularly having favorable adhesive force to resin and metal substrates. Accordingly, the inventive adhesive is excellent in heat resistance, weatherability, oil resistance, chemical resistance, solvent resistance, low-temperature properties, moisture resistance, low gas permeability, water repellency, oil repellency, etc., and particularly can exhibit favorable adhesive force to resin and metal substrates.

### EXAMPLE

Hereinafter, the present invention will be described specifically with reference to Examples and Comparative Examples, but the present invention is not restricted to the following Examples. Note that in the following examples, “%” indicates “mass%”.

### Examples 1 to 5, Comparative Examples 1 to 4

Using the following ingredients, the curable perfluoropolyether adhesive compositions shown in Table 1 were prepared. These adhesive compositions were cured under curing conditions of 130° C. and 5 minutes. The surface adhesion of each cured product was measured, and a solvent resistance test and an adhesiveness test were performed according to the methods described below. The results are shown together in Table 1.

### Ingredients

(A) Linear perfluoropolyether compound
(A-1) Difunctional perfluoropolyether (perfluoropolyether 1)

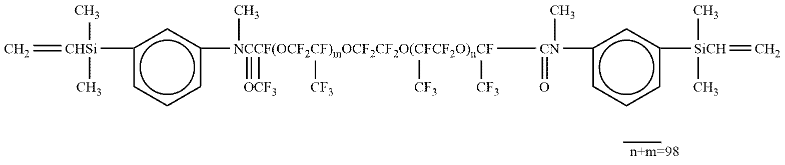

(A-2) Difunctional perfluoropolyether (perfluoropolyether 2)
CH₂═CH—CH₂—OCH₂—Rf—CH₂—O—CH₂CH═CH₂ (Rf: —CF₂O (CF₂CF₂O) _{20.8} (CF₂O) _{22.1}CF₂—)
Here, the arrangement of the repeating units CF₂CF₂O and CF₂O is random
(E) Monofunctional perfluoropolyether compound (perfluoropolyether 3)

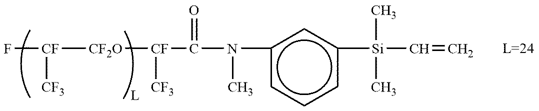

(B) Organohydrogenpolysiloxane
(b-1) Organohydrogensiloxane 1

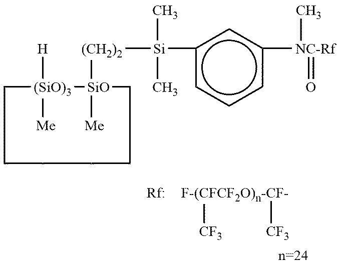

(b-2) Organohydrogensiloxane 2

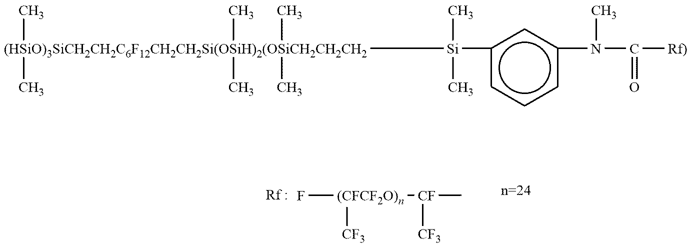

(C) Solution of platinum-divinyltetramethyldisiloxane complex in ethanol (platinum content: 3.0%)
(D) Adhesive-functional-group-containing organosilicon compound (adhesive aid)
(d-1) Adhesiveness-imparting siloxane compound (siloxane compound 1)

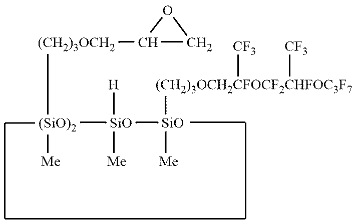

(d-2) Adhesiveness-imparting silane compound (silane compound 1)

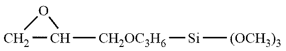

(f) Curing regulator: 50% solution of ethynylcyclohexanol in toluene

### Adhesion Measurement

The compositions of Examples and Comparative Examples were respectively applied to 50-µm thick and 25-mm wide PET (polyethylene terephthalate) films by using an applicator so as to have a thickness of 30 µm. Subsequently, each composition was cured to a rubber or gel form by heating under conditions of 130° C. and 5 minutes. Thus, adhesive tapes each having a 30-µm thick adhesive layer (cured rubber layer or cured gel layer) provided on the 50-µm thick PET film were fabricated. Each of these adhesive tapes was bonded to a metal plate (polished stainless steel plate). A roller having a weight of 2 kg and covered with a rubber layer was moved back and forth over the tape substrate once to press the adhesive tape on. The adhesive tape was left to stand at room temperature for 20 hours. Then, at 25° C., the force (N/25 mm) required to peel the adhesive tape away from the stainless steel plate at a tensile rate of 300 mm/minute at an angle of 180° was measured as the adhesion of each adhesive layer (cured rubber layer or cured gel layer) by using a tensile testing machine.

### Solvent Resistance Test (Weight Change)

3 g of one of the compositions of Examples and Comparative Examples was charged into a 32 ϕ × 15 mm glass container. Then, each composition was cured under the conditions of 130° C. and 5 minutes to produce a sample. Each sample was immersed in xylene and Fuel C (a 50/50 (wt%) mixed solution of toluene/isooctane) at 25° C. for 7 days, and the weight change rate between before and after the immersion was measured.

### Adhesiveness Test

The compositions of Examples and Comparative Examples were respectively applied to epoxy glass-made adherends so as to have a thickness of 100 µm. Then, each composition was cured to a rubber or gel form by heating under conditions of 130° C. and 5 minutes to prepare the substrate with the adhesive layer provided thereon. The adhesive layer on the substrate was rubbed with finger ten times. Each adhesive layer was evaluated as “good” if it was not peeled from the substrate, or evaluated as “poor” if it was peeled and the substrate surface was exposed.

Table 1

| Component (parts by mass) | | Example | | | | | Comparative Example | | | |
|---|---|---|---|---|---|---|---|---|---|---|
| | | 1 | 2 | 3 | 4 | 5 | 1 | 2 | 3 | 4 |
| A-1 | Perfluoropolyether 1 | 76.5 | 76.5 | 100 | 100 | | 76.5 | 76.5 | 76.5 | 100 |
| A-2 | Perfluoropolyether 2 | | | | | 100 | | | | |
| E | Perfluoropolyether 3 | 23.5 | 23.5 | | | | 23.5 | 23.5 | 23.5 | |
| b-1 | Organohydrogensiloxane 1 | 25.5 | 25.5 | | | | | 25.5 | 25.5 | |
| b-2 | Organohydrogensiloxane 2 | | | 18.1 | 1.81 | 74.7 | | | | 18.1 |
| d-1 | Siloxane compound 1 | 0.2 | | 0.2 | | | 0.2 | 0.2 | | |
| d-2 | Silane compound 1 | | 0.2 | | 0.2 | 0.2 | | | | |
| C | Platinum compound | 0.02 | 0.02 | 0.02 | 0.02 | 0.02 | 0.02 | | 0.02 | 0.02 |
| f | Curing regulator | 0.03 | 0.03 | 0.03 | 0.03 | 0.03 | 0.03 | 0.03 | 0.03 | 0.03 |
| Adhesion (N/25 mm) | | 2.4 | 2.1 | 0.06 | 0.05 | 0.04 | Not cured | Not cured | 2.0 | 0.05 |
| Solvent resistance (%) Xylene | | 2.2 | 2.5 | 1.3 | 1.2 | 1.3 | | | 2.6 | 1.2 |
| Solvent resistance (%) Fuel C | | 2.1 | 2.4 | 1.1 | 1.1 | 1.0 | | | 2.3 | 1.0 |
| Adhesiveness | | good | good | good | good | good | | | poor | poor |

As shown in Table 1, the adhesives as in Examples 1 to 5, using the inventive curable perfluoropolyether adhesive compositions, had favorable adhesiveness to the substrates. In contrast, in Comparative Examples 1 and 2, in which the essential composition of the present invention component (B) or component (C) was not contained, the compositions were not cured. Meanwhile, in Comparative Examples 3 and 4, in which the component (D) was not contained, the adhesiveness to the substrates was poor and the adhesive layers were peeled.

From the above, it has been shown that the present invention can achieve curable perfluoropolyether adhesive compositions that give cured products (adhesives) having excellent heat resistance, weatherability, water repellency, oil repellency, chemical resistance, and solvent resistance, and particularly having favorable adhesive force to substrates.

It should be noted that the present invention is not limited to the above-described embodiments. The embodiments are just examples, and any embodiments that substantially have the same feature and demonstrate the same functions and effects as those in the technical concept disclosed in claims of the present invention are included in the technical scope of the present invention.

1-7. (canceled)

8. A curable perfluoropolyether adhesive composition comprising the following components (A) to (D):
(A) 100 parts by mass of a linear perfluoropolyether compound having at least two alkenyl groups per molecule and having a perfluoropolyether structure containing a repeating unit represented by -CₐF₂ₐO- in a main chain, “a” being an integer of 1 to 6;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

9. A curable perfluoropolyether adhesive composition comprising the following components (A) to (E):
(A) 40 to 80 parts by mass of a linear perfluoropolyether compound having at least two alkenyl groups per molecule and having a perfluoropolyether structure containing a repeating unit of -CₐF₂ₐO- in a main chain, “a” being an integer of 1 to 6;
(E) 20 to 60 parts by mass of a polyfluoromonoalkenyl compound having one alkenyl group per molecule and having a perfluoropolyether structure in a main chain, a total amount of the components (A) and (E) being 100 parts by mass;
(B) an effective curing amount of an organosilicon compound having at least two silicon-bonded hydrogen atoms per molecule;
(C) a catalytic amount of a hydrosilylation-reaction catalyst; and
(D) 0.05 to 5 parts by mass of an organosilicon compound, other than the component (B), having per molecule any two or more selected from a silicon-bonded hydrogen atom, an epoxy group bonded to a silicon atom via a carbon atom or via a carbon atom and an oxygen atom, and a trialkoxysilyl group bonded to a silicon atom via a carbon atom or via a carbon atom and an oxygen atom.

10. The curable perfluoropolyether adhesive composition according to claim 9, wherein the component (E) is a polyfluoromonoalkenyl compound represented by the following general formula (2):
Rf¹—(X')ₚ—CH═CH₂ (2)
wherein X' represents —CH₂—, —OCH₂—, —CH₂OCH₂—, or —CO—NR²—Y'—, Y' represents —CH₂— or a group represented by the following structural formula (Z'), 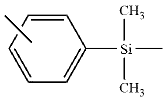
being a dimethylphenylsilylene group in an ortho-, meta-, or para-position, R
² represents a hydrogen atom, a methyl group, a phenyl group, or an allyl group, “p” represents 0 or 1, Rf¹ represents a perfluoropolyether structure represented by a general formula F—[CF(CF₃)CF₂O]_{w}—CF(CF₃)—, and “w” represents an integer of 1 to 500.

11. The curable perfluoropolyether adhesive composition according to claim 8, wherein a cured product of the curable perfluoropolyether adhesive composition is an adhesive having an adhesion of 0.001 N/25 mm to 10.0 N/25 mm.

12. The curable perfluoropolyether adhesive composition according to claim 9, wherein a cured product of the curable perfluoropolyether adhesive composition is an adhesive having an adhesion of 0.001 N/25 mm to 10.0 N/25 mm.

13. The curable perfluoropolyether adhesive composition according to claim 10, wherein a cured product of the curable perfluoropolyether adhesive composition is an adhesive having an adhesion of 0.001 N/25 mm to 10.0 N/25 mm.

14. The curable perfluoropolyether adhesive composition according to claim 8, wherein the component (A) is a linear perfluoropolyether compound represented by the following general formula (1): 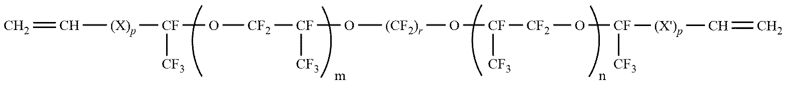
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y′ represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 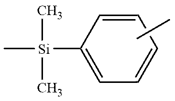
(Z) being a dimethylphenylsilylene group in an ortho-, meta-, or para-position, and 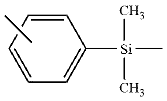
(Z') being a dimethylphenylsilylene group in an ortho-, meta-, or para-position.

15. The curable perfluoropolyether adhesive composition according to claim 9, wherein the component (A) is a linear perfluoropolyether compound represented by the following general formula (1): 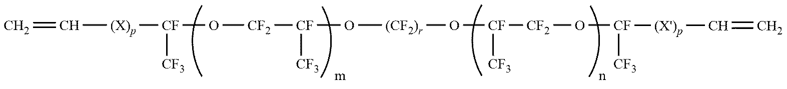
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y' represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 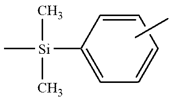
(Z) being a dimethylphenylsilylene group in an ortho-, meta-, or para-position, and 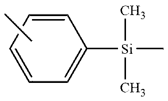
(Z′) being a dimethylphenylsilylene group in an ortho-, meta-, or para-position.

16. The curable perfluoropolyether adhesive composition according to claim 10, wherein the component (A) is a linear perfluoropolyether compound represented by the following general formula (1): 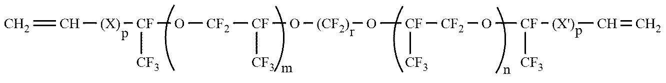
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y' represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 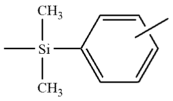
(Z) being a dimethylphenylsilylene group in an ortho-, meta-, or para-position, and 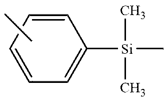
(Z') being a dimethylphenylsilylene group in an ortho-, meta-, or para-position.

17. The curable perfluoropolyether adhesive composition according to claim 11, wherein the component (A) is a linear perfluoropolyether compound represented by the following general formula (1): 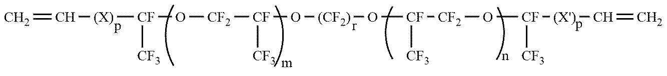
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y' represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 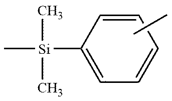
(Z) being a dimethylphenylsilylene group in an ortho-, meta-, or para-position, and 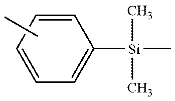
(Z'′) being a dimethylphenylsilylene group in an ortho-, meta-, or para-position.

18. The curable perfluoropolyether adhesive composition according to claim 12, wherein the component (A) is a linear perfluoropolyether compound represented by the following general formula (1): 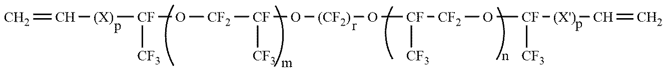
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y' represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 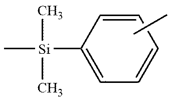
(Z) being a dimethylphenylsilylene group in an ortho-, meta-, or para-position, and 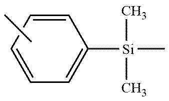
(Z') being a dimethylphenylsilylene group in an ortho-, meta-, or para-position.

19. The curable perfluoropolyether adhesive composition according to claim 13, wherein the component (A) is a linear perfluoropolyether compound represented by the following general formula (1): 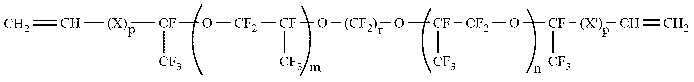
wherein X represents —CH₂—, —CH₂O—, —CH₂OCH₂—, or —Y—NR¹—CO—, Y represents —CH₂— or a group represented by the following structural formula (Z), R¹ represents a hydrogen atom, a methyl group, a phenyl group, or an allyl group, X' represents —CH₂—, —OCH₂—, —CH₂OCH₂—, or —CO—NR²—Y'—, Y'′ represents —CH₂— or a group represented by the following structural formula (Z'), R² represents a hydrogen atom, a methyl group, a phenyl group, or an allyl group, “p” independently represents 0 or 1, “r” represents an integer of 2 to 6, “m” and “n” each represent an integer of 0 to 600, a sum of “m” and “n” further being 50 to 600, 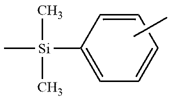
(Z) being a dimethylphenylsilylene group in an ortho-, meta-, or para-position, and 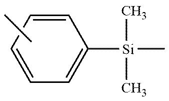
(Z') being a dimethylphenylsilylene group in an ortho-, meta-, or para-position.

20. The curable perfluoropolyether adhesive composition according to claim 8, wherein a cured product of the curable perfluoropolyether adhesive composition is a non-conductive adhesive having a volume resistivity of 1×10⁹ Ω·cm or more.

21. The curable perfluoropolyether adhesive composition according to claim 9, wherein a cured product of the curable perfluoropolyether adhesive composition is a non-conductive adhesive having a volume resistivity of 1×10⁹ Ω·cm or more.

22. An adhesive comprising a cured product of the curable perfluoropolyether adhesive composition according to claim 8.

23. An adhesive comprising a cured product of the curable perfluoropolyether adhesive composition according to claim 9.
